(19) United States
(12) Patent Application Publication
(10) Pub. No.: US 2013/0037735 A1
(43) Pub. Date: Feb. 14, 2013

(54) Overmolding Ball Valve

(71) Applicant: Ching-Fu Hsieh, Lu Kang Chen (TW)

(72) Inventor: Ching-Fu Hsieh, Lu Kang Chen (TW)

(21) Appl. No.: 13/205,746

(22) Filed: Aug. 9, 2011

(51) Int. Cl. F16K 31/44

(52) U.S. Cl. 251/231

(57) ABSTRACT

An overmolding ball valve contains a body including a hole and a control lever; a first housing covered on the body and including two first orifices, a second orifice to correspond to the control lever, the body being received in the first housing, the control lever extending out of the second orifice so that the body is capable of rotating in the first housing; a second housing to cover the body and the first housing being injection molded and including a chamber, two channels disposed on the chamber to correspond to the two ends of the hole individually, and a seat secured on another end of the chamber to correspond to the control lever, the body and the first housing being fixed in a mold to injection mold the second housing, the body and first housing are located at the chamber, and the control level extending out of the seat.

### BACKGROUND OF THE INVENTION

1. Field of the Invention

The present invention relates to a ball valve fixed between a fluid pipes to turn on and off the fluid, and more particularly to an overmolding ball valve.

2. Description of the Prior Art

A conventional ball valve comprises a combined ball valve and an insert molded ball valve. As shown in FIG. 14, the insert molded ball valve contains a ball valve 90 including a peripheral ball 91 injected and placed in another cavity to insert mold a body 92, however, during insert molding process of the body 92, the peripheral ball 91 generates a hot melted portion to combine with the body 92, having a poor yield. When the body 92 is injection molded to cover the peripheral ball 91, the body 92 can not cover the peripheral ball 91 equally to form the ball valve 90 tightly, hence the peripheral ball 91 rotates poorly.

Before forming the ball valve 90, two stopping members 93 are placed on two ends of the peripheral ball 91, and the body 92 is insert injection. Nevertheless, during injecting the body 92, a large pressure generates in the cavity to push the stopping members 93 away from a predetermined position, thus leaking water easily.

The present invention has arisen to mitigate and/or obviate the afore-described disadvantages.

### SUMMARY OF THE INVENTION

The primary object of the present invention is to provide an overmolding ball valve in which the first housing is covered on the body, and the body covered by the first housing and the first housing are placed in the mold to injection mold the second housing, so when the first housing is made of the metal material, the second housing injection molded will not hot melt the first housing to prevent the second housing from contacting with the body directly to enhance a yield of the ball valve.

Another object of the present invention is to provide an overmolding ball valve in which the body covered by the first housing and the first housing are placed in the mold to injection mold the second housing, hence an engagement between the body and the first housing is controlled evenly to increase a rotating force of the body evenly and a compressive resistance.

To obtain the above objectives, an overmolding ball valve provided by the present invention contains:

a body including a hole disposed in a central portion thereof and a control lever extending outward from an outer peripheral side thereof;

a first housing covered on the outer peripheral side of the body and including two first orifices fixed on the outer peripheral side of the body which corresponds to two ends of the hole respectively, a second orifice to correspond to the control lever, the body being received in the first housing, and the control lever extending out of the second orifice so that the body is capable of rotating in the first housing;

a second housing to cover the body and the first housing being injection molded and including a chamber, two channels disposed on two ends of the chamber to correspond to the two ends of the hole individually, and a seat secured on another end of the chamber to correspond to the control lever, the body and the first housing being fixed in a mold to injection mold the second housing, the body and first housing are located at the chamber, and the control level extending out of the seat.

### BRIEF DESCRIPTION OF THE DRAWINGS

FIG. 1 is a cross-sectional perspective view showing the assembly of an overmolding ball valve according to a first embodiment of the present invention;

FIG. 2 is a perspective view showing the exploded components of a body and a first housing of the overmolding ball valve according to the first embodiment of the present invention;

FIG. 3 is a perspective view showing the assembly of the body and the first housing of the overmolding ball valve according to the first embodiment of the present invention;

FIG. 4 is a cross sectional view showing the assembly of the overmolding ball valve according to the first embodiment of the present invention;

FIG. 5 is another perspective view showing the exploded components of the body and the first housing of the overmolding ball valve according to the first embodiment of the present invention;

FIG. 6 is another perspective view showing the assembly of the body and the first housing of the overmolding ball valve according to the first embodiment of the present invention;

FIG. 7 is another perspective view showing the exploded components of the overmolding ball valve according to the first embodiment of the present invention;

FIG. 8 is a cross-sectional perspective view showing the assembly of an overmolding ball valve according to a second embodiment of the present invention;

FIG. 9 is another cross-sectional perspective view showing the assembly of the overmolding ball valve according to the second embodiment of the present invention;

FIG. 10 is a perspective view showing the assembly of a body and a first housing of the overmolding ball valve according to the second embodiment of the present invention;

FIG. 11 is an amplified view of a part of FIG. 10;

FIG. 12 is a cross-sectional view showing the assembly of the body and the first housing of the overmolding ball valve according to the second embodiment of the present invention;

FIG. 13 is an amplified view of a part of FIG. 12;

FIG. 14 is a cross sectional view showing the assembly of a conventional overmolding ball valve.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

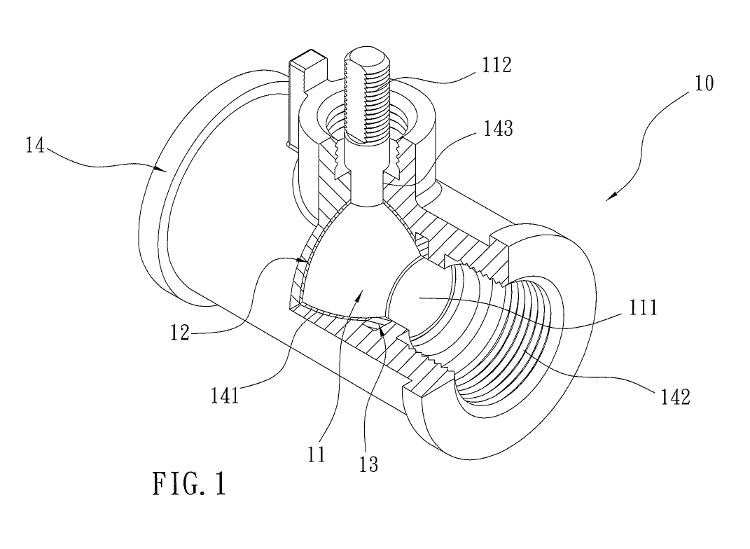

With reference to FIGS. 1-3, an overmolding ball valve 10 according to a first embodiment of the present invention comprises:

a body 11 formed in a circular ball shape and including a hole 111 disposed in a central portion thereof and a control lever 112 extending outward from an outer peripheral side thereof and integrally injection molded or connection formed, the body 11 being made of plastic material, metal material or ceramics material;

a first housing 12 covered on the outer peripheral side of the body 11 and including two first orifices 121 fixed on the outer peripheral side of the body 11 which corresponds to two ends of the hole 111 respectively, wherein a diameter of the first orifice 121 is larger that that of the hole 111, the first housing 12 also including a second orifice 122 to correspond to the control lever 112 and a gap 123 formed between the two orifices 121, and the body 11 is made of plastic material or metal material.

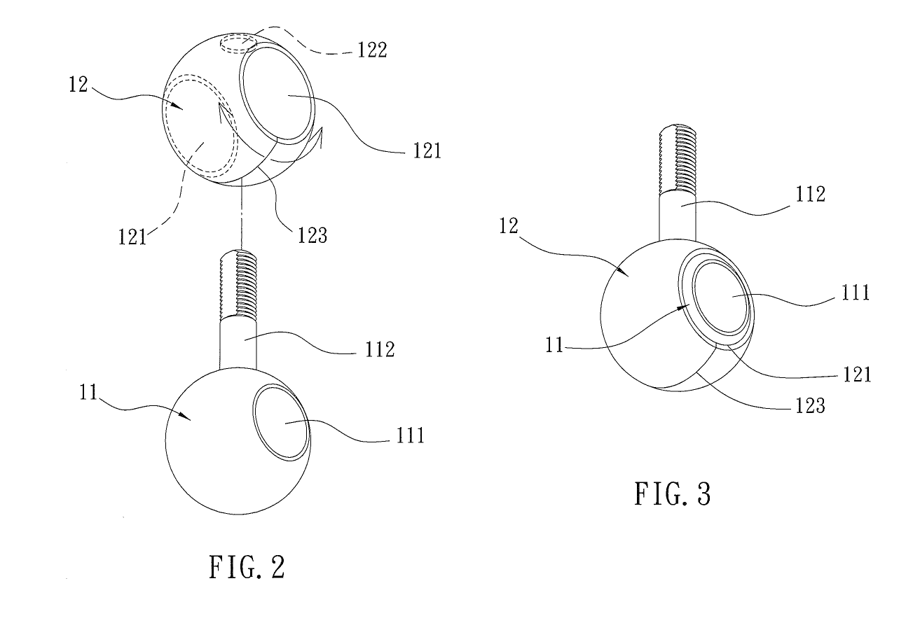

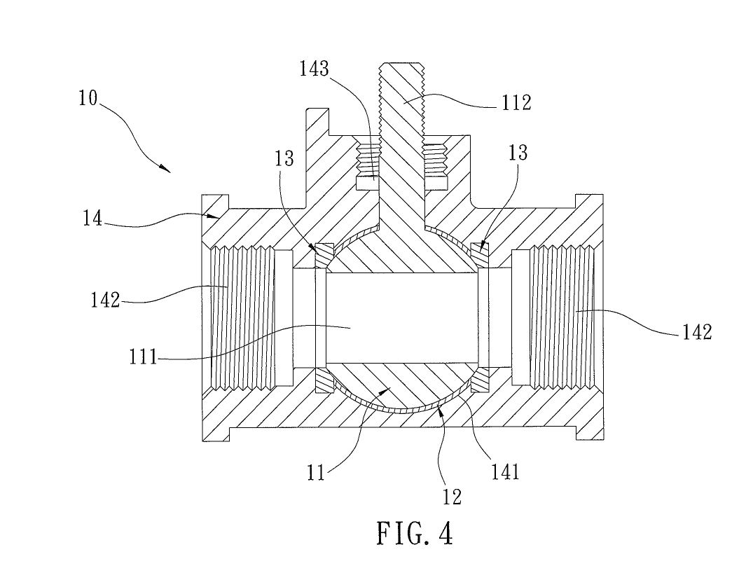

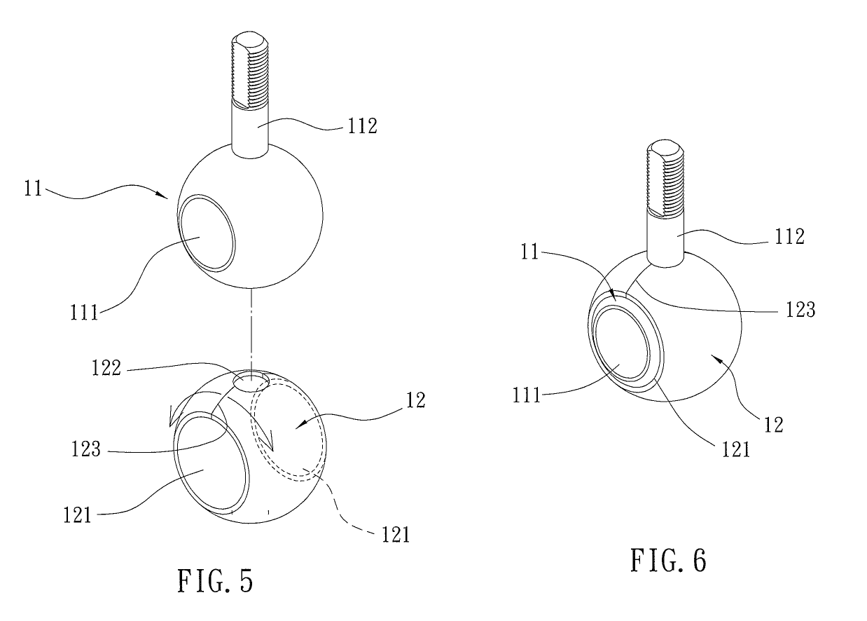

The first housing 12 is capable of expending resiliently by using the gap 123 shown by an arrow of FIG. 2 so that the body 11 is received in the first housing 12, and the control lever 112 extends out of the second orifice 122 so that the body 11 is capable of rotating in the first housing 12 as illustrated in FIG. 4, wherein the gap 123 is fixed on a first position of the first housing 12 as shown in FIGS. 2 and 3 or a second position of the first housing 12 as illustrated in FIGS. 5 and 6 to obtain an equivalent function.

Two stopping members 13 are formed in a circular loop shape and made of polytetrafluoroethene material to stop water and are fixed on the two ends of the hole 111 and in the two first orifices 121 respectively.

A second housing 14 to cover the body 11, the first housing 12, and the two stopping members 13 are injection molded and includes a chamber 141, two channels 142 disposed on two ends of the chamber 141 to correspond to the two ends of the hole 111 individually, and a seat 143 secured on another end of the chamber 141 to correspond to the control lever 112, wherein the two channels 142 are connected with an inlet end and an outlet end respectively.

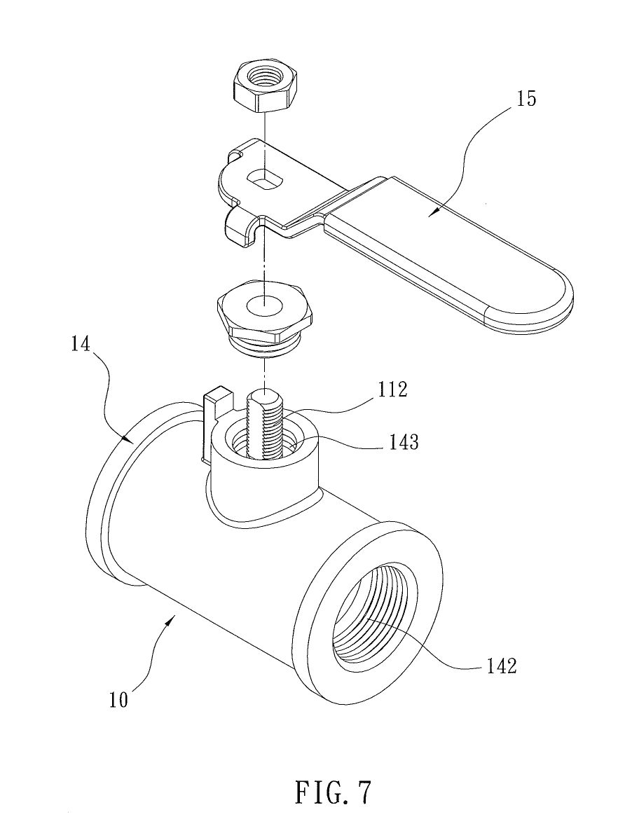

The body 11, the first housing 12, and the two stopping members 13 are fixed in a mold to injection mold the second housing 14, the body 11 and first housing 12 are located at the chamber 141, and the two stopping members 13 correspond to the two channels 142 individually and are used to prevent fluid between the channels 142, the inlet end, and the outlet from leak and to prevent the fluid from leaking into the seat 143, the control level 112 extends out of the seat 143 to couple with a grip 15 as illustrated in FIG. 7.

The first housing 12 is covered on the body 11, and the body 11 covered by the first housing 12 and the first housing 12 are placed in the mold to injection mold the second housing 14, so when the first housing 12 is made of the metal material, the second housing 14 injection molded will not hot melt the first housing 12 to prevent the second housing 14 from contacting with the body 11 directly to enhance a yield of the ball valve 10; when the first housing 12 is made of the plastic material, the second housing 14 injection molded will only hot melt the first housing 12 without hot melting the body 11 to prevent the second housing 14 from connecting with the body 11 directly, thus enhancing the yield of the ball valve 10.

Furthermore, the body 11 covered by the first housing 12 and the first housing 12 are placed in the mold to injection mold the second housing 14, hence an engagement between the body 11 and the first housing 12 is controlled evenly to increase a rotating force of the body 11 evenly and a compressive resistance of the ball valve 10.

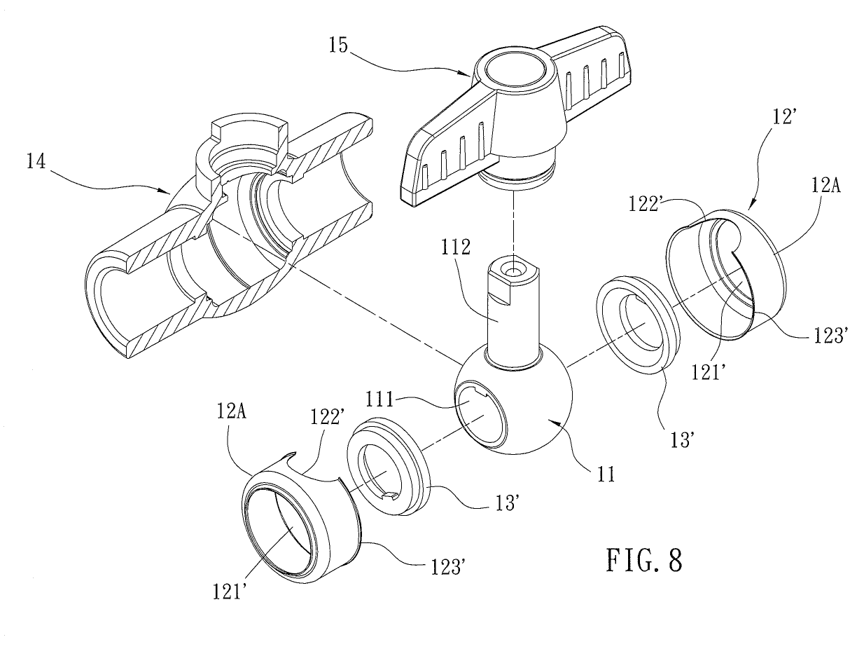

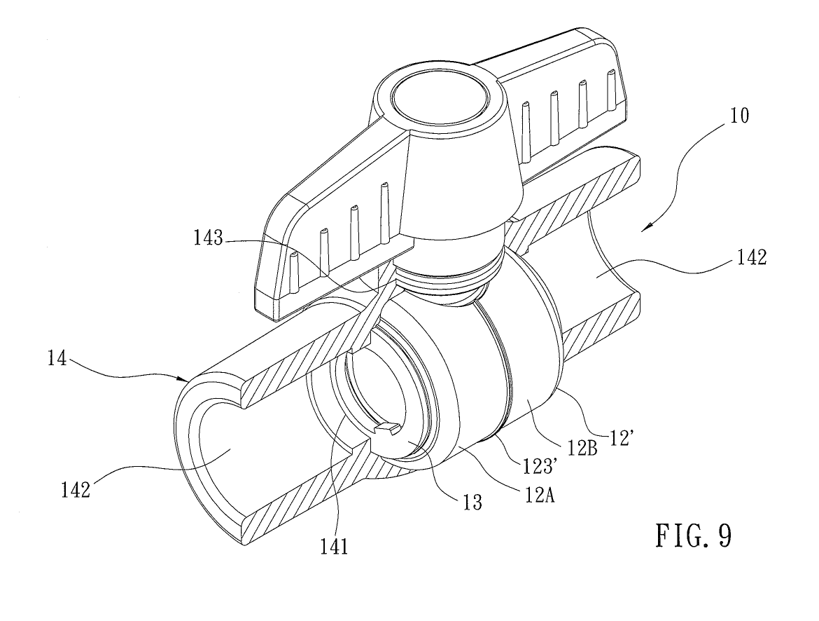

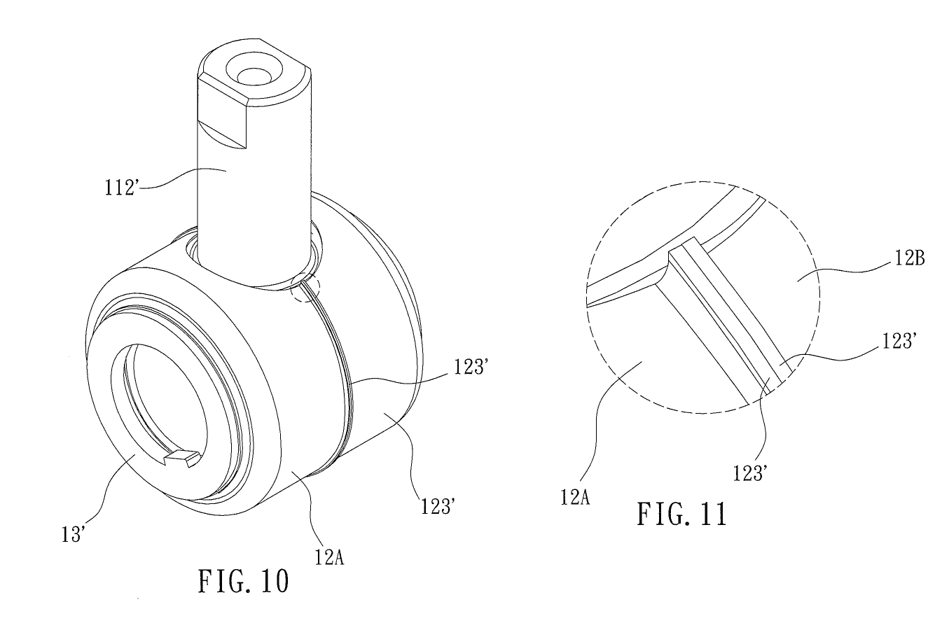

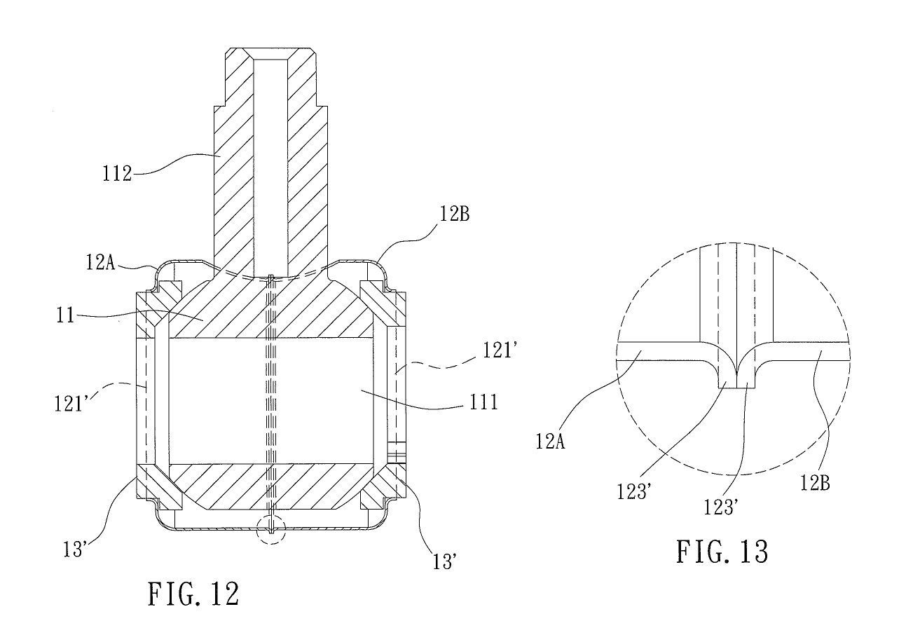

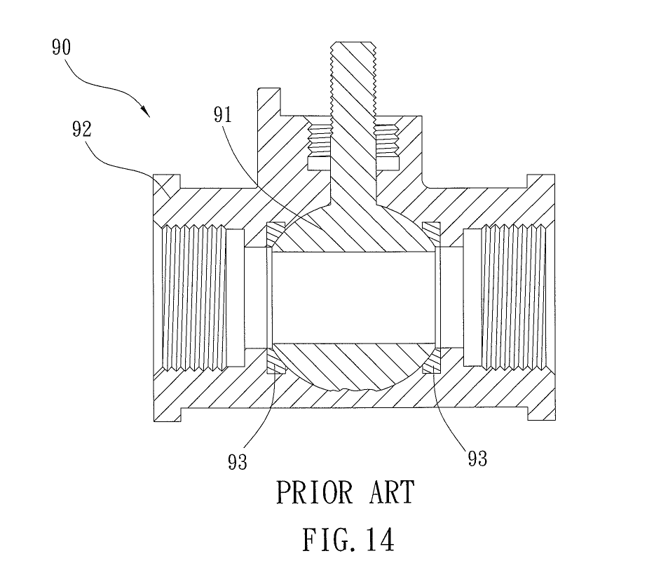

With reference to FIGS. 8-13, an overmolding ball valve according to a second embodiment of the present invention comprises:

a first housing 12′ including a first part 12A and a second part 12B connecting together and used to cover an outer peripheral side of a body 11, and the first housing 12′ also including two first orifices 121′ fixed thereon to correspond to two ends of the hole 111 respectively and a second orifice 122′ to correspond to a control lever 112, and a connection of the first part 12A and the second part 12B is defined a rib 123′ to enhance an engagement between the first part 12A and the second part 12B, two stopping members 13′ fixed between the hole 111 and the first orifices 121′, a second housing 14 is injection molded to increase a water stopping effect.

While we have shown and described various embodiments in accordance with the present invention, it is clear to those skilled in the art that further embodiments may be made without departing from the scope of the present invention.

What is claimed is:

1. An overmolding ball valve comprising:
a body including a hole disposed in a central portion thereof and a control lever extending outward from an outer peripheral side thereof;
a first housing covered on the outer peripheral side of the body and including two first orifices fixed on the outer peripheral side of the body which corresponds to two ends of the hole respectively, a second orifice to correspond to the control lever, the body being received in the first housing, and the control lever extending out of the second orifice so that the body is capable of rotating in the first housing;
a second housing to cover the body and the first housing being injection molded and including a chamber, two channels disposed on two ends of the chamber to correspond to the two ends of the hole individually, and a seat secured on another end of the chamber to correspond to the control lever, the body and the first housing being fixed in a mold to injection mold the second housing, the body and first housing are located at the chamber, and the control level extending out of the seat.

2. The overmolding ball valve as claimed in claim 1, wherein the first housing also includes a gap formed thereon and is capable of expending resiliently by using the gap so that the body is received in the first housing.

3. The overmolding ball valve as claimed in claim 2, wherein the gap is formed between the two orifices.

4. The overmolding ball valve as claimed in claim 1, wherein a diameter of the first orifice is larger that that of the hole and further comprises two stopping members formed in a circular loop shape and fixed on the two ends of the hole and in the two first orifices respectively;
a second housing injection molded and covering the two stopping members.

5. The overmolding ball valve as claimed in claim 1, wherein the control level couples with a grip.

6. The overmolding ball valve as claimed in claim 1, wherein the first housing includes a first part and a second part connecting together and a connection of the first part and the second part is defined a rib.

7. The overmolding ball valve as claimed in claim 1 further comprising the two stopping members formed in a circular loop shape and between the hole and in the two first orifices, and the second housing is injection molded to cover the two stopping members.
